(19) United States
(12) Patent Application Publication
(10) Pub. No.: US 2023/0262669 A1
(43) Pub. Date: Aug. 17, 2023

(54) TIME DOMAIN RESOURCE ALLOCATION FOR NON-TERRESTRIAL NETWORKS

(71) Applicant: ZTE Corporation, Shenzhen (CN)

(72) Inventors: Jianqiang Dai, Shenzhen (CN); Nan Zhang, Shenzhen (CN)

(21) Appl. No.: 18/302,288

(22) Filed: Apr. 18, 2023

Related U.S. Application Data
(63) Continuation of application No. PCT/CN2021/072196, filed on Jan. 15, 2021.

(51) Int. Cl. H04W 72/0446; H04W 72/20; H04L 1/1812

(52) U.S. Cl. CPC H04W 72/0446; H04W 72/20; H04L 1/1812

(57) ABSTRACT

This patent document describes, among other things, techniques, and apparatuses for providing non-terrestrial network connectivity to improve wireless network efficiency and performance. In one aspect, a method of wireless communication is disclosed. The method includes receiving, at a wireless device from a network node, an enhanced control information, wherein the enhanced control information includes one or more bit fields indicative of a timing information. The method further includes performing subsequent communication between the wireless device and the network node based on the enhanced control information.

### CROSS REFERENCE TO RELATED APPLICATIONS

This patent document is a continuation of and claims benefit of priority to International Patent Application No. PCT/CN2021/072196, filed on Jan. 15, 2021. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. This demand has expanded to data connectivity to airborne platforms. Aspects, such as energy consumption, device cost, spectral efficiency, and latency are also important to meeting the needs of various communication scenarios. Various techniques, including new ways to provide higher quality of service including service on airborne platforms and service provided by airborne platforms are being discussed.

### SUMMARY

This patent document describes, among other things, techniques, and apparatuses for providing non-terrestrial network connectivity to improve wireless network efficiency and performance.

In one aspect, a method of wireless communication is disclosed. The method includes receiving, at a wireless device from a network node, an enhanced control information, wherein the enhanced control information includes one or more bit fields indicative of a timing information. The method further includes performing subsequent communication between the wireless device and the network node based on the enhanced control information.

In another aspect, another method for wireless communications is disclosed. The method includes configuring, at a network node, an enhanced control information, wherein the enhanced control information includes one or more bit fields indicative of a timing information. The method further includes performing communication between the network node and a wireless device based on the enhanced control information.

In another aspect, a wireless communication apparatus comprising a processor configured to implement a method described herein is disclosed.

In another aspect, computer readable medium including executable instructions to implement a method described herein is disclosed.

These, and other, aspects are described in the present document.

### BRIEF DESCRIPTION OF DRAWINGS

FIG. 1 shows an example non-terrestrial network system where techniques in accordance with one or more embodiments of the present technology can be applied.

FIG. 2 shows an example of a large process number and an associated timing indicator.

FIG. 3 shows an example of a timing for HARQ feedback in a case of 32 HARQ processes DL transmissions.

FIG. 4 shows an example of no collision between an uplink transmission and a downlink reception during a scheduling offset.

FIG. 5 shows an example of no collision between an uplink transmission and a downlink reception with a known timing advance.

FIG. 6 shows an example of a process for wireless communication.

FIG. 7 shows another example of a process for wireless communication.

FIG. 8 shows a block diagram representation of a portion of a radio station in accordance with one or more embodiments of the present technology.

### DETAILED DESCRIPTION

Certain features are described using the example of Fifth Generation (5G) wireless protocol. However, applicability of the disclosed techniques is not limited to only 5G wireless systems. The following description includes section headings for organization and to enhance clarity without limiting various combinations of the features under the various headings.

Many cellular network operators have both mobile network and fixed network operations. Many operators provide service combining mobile communication, fixed telephony, and broadband Internet, and some providers television service as well. Operators can distinguish themselves by providing an optimal integration between the different services. Following the trend of expanded service scenarios, operators are looking to support airborne user equipment (UEs) as well as providing service from airborne base stations.

Connectivity via satellites and/or airborne vehicles is a promising technology to expand the utilization of the fifth-generation (5G) new radio (NR) and long-term evolution (LTE) system access technologies. A network incorporating satellites and/or airborne vehicles to perform the functions (either full or partial) of terrestrial base stations (BSs) may be referred to as a non-terrestrial network (NTN). NTN's also include UEs that are airborne being served by satellites and/or airborne base stations.

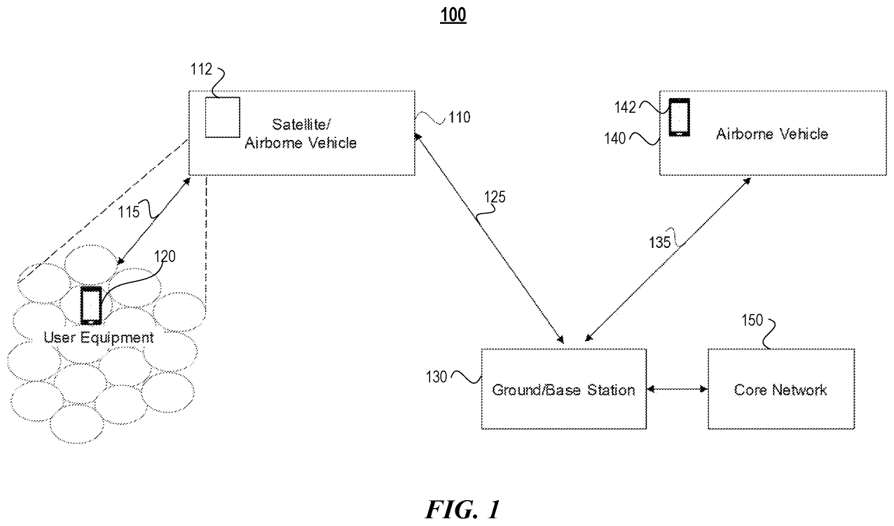

FIG. 1 shows an example NTN system 100 where techniques in accordance with one or more embodiments of the present technology can be applied. A satellite/airborne vehicle 110 carries an airborne base station 112 that communicates wireles sly via communications link 115 with UE 120 on the ground in a particular cell. Airborne base station 112 may serve multiple cells on the ground using different antenna beams and/or steerable antenna beams. satellite/airborne vehicle 110 connects to ground based ground/base station 130 or an airborne gateway (not shown). The ground/base station provides data connectivity to core station 150. Ground/base station 130 also communicates with airborne UE 142 over communications station 135. Airborne UE 142 is carried on airborne vehicle 140 such as a manned aircraft, unmanned aerial vehicle (UAV), drone, balloon, or other air vehicle.

The core station 150 can communicate with one or more base stations 130. The core station 150 provides connectivity with other wireless communication systems and wired communication systems. The core network may include one or more service subscription databases to store information related to the subscribed wireless devices 120 and 142. A first base station 112 can provide wireless service based on a first radio access technology, whereas a second base station 130 can provide wireless service based on a second radio access technology. The wireless devices 120 and 142 can support multiple different radio access technologies. The techniques and embodiments described in the present document may be implemented by the base stations described in the present document or by wireless devices.

With current NTN approaches using a time division duplexing (TDD) serving cell, when a hybrid automatic repeat request HARQ process number is large, the indication of a time resource allocation for a corresponding HARQ feedback of each PDSCH cannot be accommodated using current control information. For example, when the HARQ process number is larger than 16.

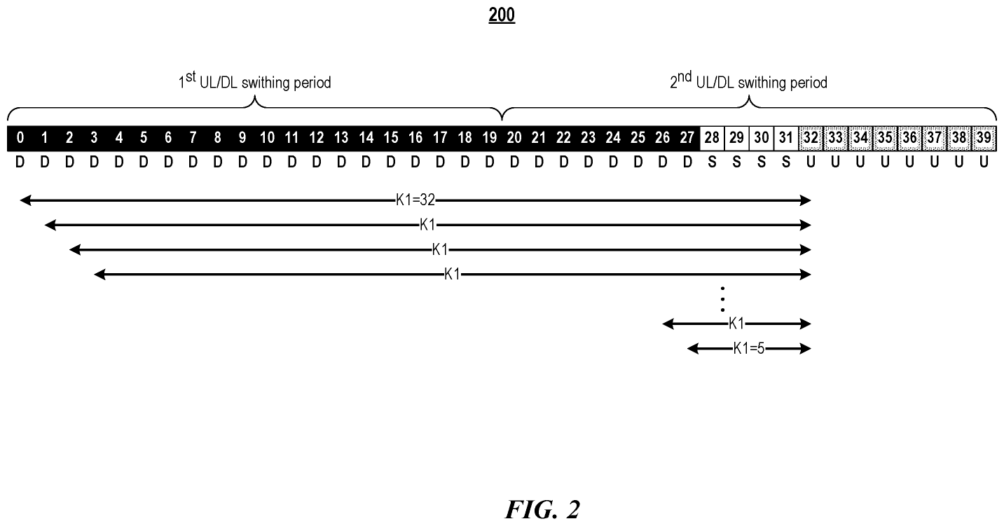

FIG. 2 shows an illustrative example of some aspects of the disclosed subject matter. As shown in the FIG. 2, when the maximum HARQ process number is larger than 16, e.g. the number is 28, and the HARQ-ACK feedback is scheduled for transmission in slot 32, then the value of ‘PDSCH-to-HARQ_feedback timing indicator’ should be different per consecutive downlink (DL) transmission with respective HARQ process ID. For example, for the DL transmission in slot 0, and K1 is 32, while for the transmission in slot 27, K1 is 5.

However, currently the control information field can only support eight different candidates, and the maximum value of the indicator is 15, which is not sufficient to ensure the time resource for all HARQ-ACK feedback can be allocated. With an extension to the value of K1, an available UL resource can be ensured to be available for the HARQ-ACK feedback.

In the fifth-generation (5G) new radio (NR) a 3 bit field ‘PDSCH-to-HARQ_feedback timing indicator’ in DCI format 1_0 is used for indicating a value of time offset K1.

‘Time domain resource allocation’ is used for time domain resource allocation for scheduling PUSCH in DCI 0_0/DCI 0_1. A 4-bit field is defined with a default table including configurations of ‘K2’, ‘PUSCH mappingType’, ‘position of start symbol’, and ‘slot length’.

For a TDD configuration, the UL/DL slot/symbol should be flexibly configured.

### Extension of ‘K1’

In a first case when the supported HARQ process number is larger than a value, x, the DCI content includes an enhanced bit field which indicates a value of ‘K1’.

Base Station

The need for DCI enhancement depends on the supported HARQ process number. For some UEs, if configuring the HARQ process number in the range of {A}, the BS may configure a legacy bit field in the DCI. For some UEs, if configuring the HARQ process number beyond the range of {A}, the BS may configure an enhanced bit field in the DCI. For an NTN UE, the BS may configure the enhanced DCI and/or enhanced bit field according to the configured value of HARQ process number. for example, when the HARQ process number is beyond the range of {A}, such as ‘A’ is the number of values of ‘K1’ indicated in DCI.

User Device

If the UE is configured with a HARQ process number in the range of {A}, the UE tries to detect a legacy DCI. For example, if the UE detects a DCI scheduling a PDSCH reception ending in slot n or if the UE detects a DCI indicating a SPS PDSCH release through a PDCCH reception ending in slot n, the UE provides corresponding HARQ-ACK information in a PUCCH transmission within slot n+K1. K1 is indicated via the legacy bit field.

If the UE is configured with a HARQ process number beyond the range of {A}, the UE tries to detect an enhanced DCI, e.g. if the UE detects a DCI scheduling a PDSCH reception ending in slot n or if the UE detects a DCI indicating a SPS PDSCH release through a PDCCH reception ending in slot n, the UE provides corresponding HARQ-ACK information in a PUCCH transmission within slot n+K1. K1 is indicated via the enhanced bit field.

Enhanced Bit Field

An enhanced bit field can include, for example, a ‘PDSCH-to-HARQ_feedback timing indicator’, this that is a number of bits, x, and indicates a value of K1, where x is larger than 3. The x bits indicate a value in a list of y values, and y is larger than 8. For example, the first value of the x bits (‘00000’) refers to the first value of the list, the second value of the x bits (‘00001’) refers to the second value of the list, and so on. In some embodiments, y<=2^{x}.

Extension of Value Range of ‘K1’

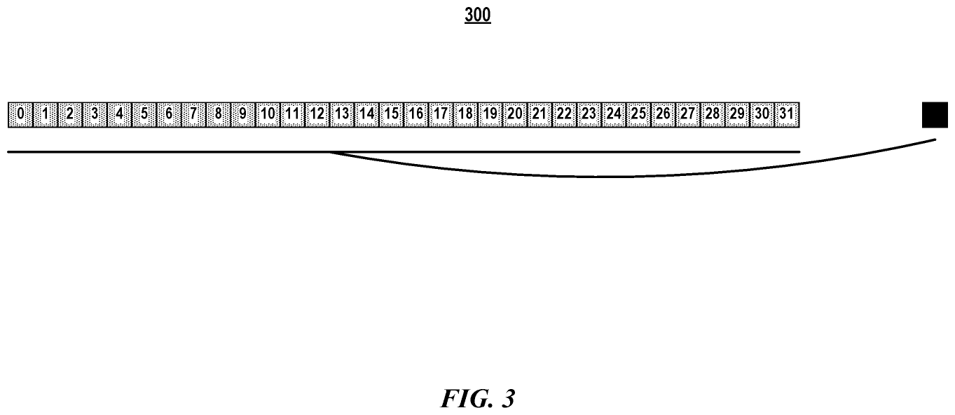

As FIG. 3 illustrate, in a case of 32 HARQ processes DL transmissions, if a shared time resource is allocated for the PUCCH transmission to covey all the HARQ feedback, then at least 32 values of time offset (K1) need to be defined or indicated in the DCI for each PDSCH. In this case, the value range of ‘K1’ may be a list including 32 values. For example, a set of values may be expressed as: {32,31,30,29,28,27,26,25,24,23,22,21,20,19,18,17,16,15,14,13,12,11,10,9,8,7,6,5,4,3,2,1 }

In some embodiments, the value range of K1 may be configured via a high layer configuration. For example, the range of candidate values of K1 may be from 0 to 31, or from 1 to 32.

Introducing a scheduling K_offset, which means if the UE detects a DCI scheduling a PDSCH reception ending in slot n or if the UE detects a DCI indicating a SPS PDSCH release through a PDCCH reception ending in slot n, the UE provides corresponding HARQ-ACK information in a PUCCH transmission within slot n+K1+K_offset. K_offset is involved in the round-trip delay and timing advance mechanism. In some embodiments, K_offset is a common value for UEs in a cell/beam. In some embodiments, K_offset is derived from the value of TA executed by a UE. In some embodiments, K_offset is an integer.

The common part/time shift of K1 can be absorbed/included in the value of K_offset in the polynomial ‘n+K1+K_offset’. In this case, the value range of ‘K1’ may be a list of 32 values, for example: {32,31,30,29,28,27,26,25,24,23,22,21,20,19,18,17,16,15,14,13,12,11,10,9,8,7,6,5,4,3,2,1 }.

Re-Interpreting the Bit Field ‘PDSCH-To-HARQ_Feedback Timing Indicator’, so that the Bit Field Indicates an Extension Value Range of ‘K1’.

The bit in another bit field, such as a bit in the modulation and coding scheme (MCS) bit field is reused to jointly indicate the value of ‘K1’ with the legacy bit field ‘PDSCH-to-HARQ_feedback timing indicator’. For example, in this case, four (or another number) bits in total can be used to indicate an extension value range of ‘K1’. The legacy bit field can be re- interpreted as three bits out of the total four bit indicator. For example, the last three bits of the indicator or the first three bits of the indicator.

In some embodiments, one bit in the MCS bit field is the MSB of this bit field. In some embodiments, one bit in RV bit field is reused to jointly indicate the value of ‘K1’ with the legacy bit field ‘PDSCH-to-HARQ_feedback timing indicator’.

In some embodiments, both the information of legacy ‘K1’ and ‘HARQ process number’ can be considered for re-interpreting the bit filed ‘PDSCH-to-HARQ feedback timing indicator’. In other words, the BS configures an extended ‘K1’ according to the value of legacy ‘K1’ and the value of corresponding HARQ process ID.

For example, if the first value list of K1 is {1,2,3,4,5,6,7,8}, the maximum HARQ process number is 32. If a HARQ process number is 0, K1 =1, configuring the time offset to be K1+31−0, then the extended value of K1 is 32. If a HARQ process number is 1, K1=1, configuring the time offset to be K1+31−1, then the extended value of K1 is 31. In some embodiments, the HARQ process number is disordered along the time considering the different time occasion of retransmission of each HARQ process.

### Flexible Time Domain Resource Allocation of Scheduling PUSCH

Enhance DCI by Adding New Entries and/or Adjusting the Entries of the Table

An x bit length bit field ‘time domain resource assignment’ can be used for indicating the time domain resource allocation of scheduling PUSCH. If enlarging the bit field ‘time domain resource assignment’ it means new entries are added in the table. For example, when x is larger than four, the value of x can refer to the row index in a time domain resource allocation table.

In some embodiments, the time domain resource allocation table is determined/configured taking into consideration of the SFI configuration.

Several configurations are added as shown in the following table when SFI=32.

| | PUSCH | | | |
|---|---|---|---|---|
| Row index | mapping type | K₂ | S | L |
| New num1 | Type B | j | 13 | 2 |
| New num2 | Type B | j + 3 | 13 | 2 |

In some embodiments, a time domain resource assignment table is configured, including a mix of legacy rows of configuration and new rows of configuration.

Multiple and flexible time offset as well as the start symbol location and slot length may be used in exact scenarios.

| | PUSCH | | | |
|---|---|---|---|---|
| Row index | mapping type | K₂ | S | L |
| 1 | Type B | j | 2 | 10 |
| 2 | Type B | j | 4 | 10 |
| 3 | Type B | j | 4 | 8 |
| 4 | Type B | j | 4 | 6 |
| 5 | Type B | j | 8 | 6 |
| 6 | Type B | j + offset | x1 | x2 |
| 7 | Type A | j + offset | x1 | x2 |

In the new rows, the ‘offset’ may depend on a round trip delay (RTD) of a specific scenario, e.g., air to ground (ATG) , ‘x1, x2’ depends on the SFI configuration, ‘offset’, ‘x1’, ‘x2’ are fixed values in a table.

Other Extensions of K1/K2

Considering the existing scheduling offset (i.e., K1, K2) and can be dynamic indicated, a wide range of K1/K2 can provide more schedule flexibility and allow service with larger beam foot print. Even if K1 ,K2 are large enough to handle the TA impact in a scenario such as a high altitude platform station (HAPS), signaling of K_offset may be saved.

In the case of UE specific updates to scheduling offset in a large beam/ATG case, for example, the maximum differential round trip delay is 3.18*2 ms. The indicated K2 in the bit field ‘Time domain resource assignment’ is ignored and replace by a signaling ‘new_K2’ with extend value range ,e.g. x bits of the bit field ‘new_K2’ is used for indicating time offset between scheduling PUSCH and corresponding detected DCI.

Timing of Monitoring NB-IoT Physical Downlink Control Channel (NPDCCH) Control Information for Half duplex-FDD UE

For NB-IoT, there is constraint on the UE monitoring NPDCCH in a period of time. For example, when a UE detects NPDCCH with DCI Format NO ending in subframe n, and the NPUSCH format 1 transmission starts from subframe n+k, the UE may be not required to monitor an NPDCCH candidate from subframe n+1 to subframe n+k−1.

In the above case, the UE is not required to monitor a PDCCH during the whole scheduling delay e.g. the value of k. However, if the K_offset is introduced in the time relationship case due to the long RTD in a NTN network, then the limitation in the spec may be modified accordingly as follows:

In some example embodiments, the UE is not required to monitor an NPDCCH candidate in any subframe starting from subframe n+1 to subframe n+k+K_offset−1. In some embodiments, a time slot is one subframe. In another embodiments, a time slot is 1 milliseconds/2^{x}. In another embodiments, a time slot is 1 milliseconds*2^{x}.

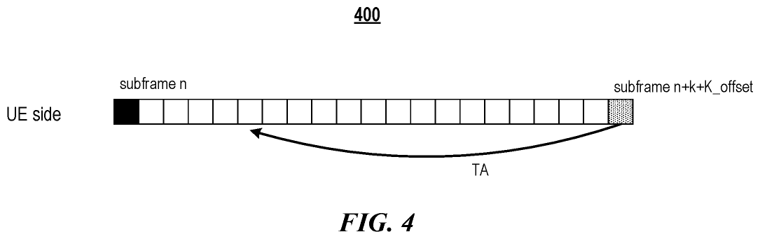

The limit can ensure avoiding the potential collision between the UL transmission (with unknown TA) and DL receiving (e.g. receiving NPDCCH) as FIG. 4 depicts. FIG. 4 shows no collision between UL transmission and DL receiving during a scheduling offset.

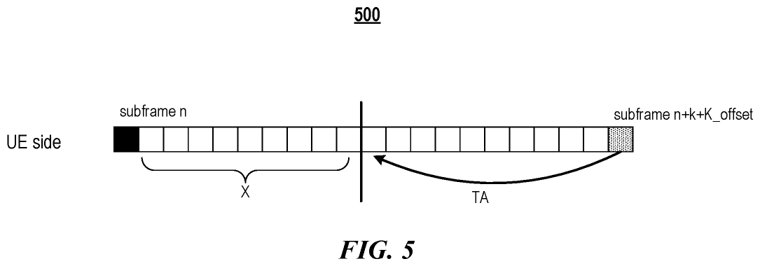

If the TA is known at both the BS and UE, or the TA does not exceed a boundary as FIG. 5 shows an example of no collision between an uplink transmission and a downlink reception with a known 5 shows, the collision can also be avoided. Meanwhile an extra piece of time resource donated as ‘X’ in the figure may be exploited if the constraint was relaxed. So another kind of spec modification accordingly may be as follows:

The UE is not required to monitor an NPDCCH candidate in any subframe starting from subframe n+k+Koffset−TA to subframe n+k+Koffset−1.

FIG. 5 shows an example of no collision between an uplink transmission and a downlink reception with a known timing advance.

In the second way of modification, potential enhancements can be made based on utilizing the remaining resource in ‘X’ except the necessary time gap between the receiving DL and the actual UL transmission.

### Time Offset is Added on Top of a Reference Value

Different values of time offset along with corresponding can be configured in various cases. For example, the value range can be between 0 and 64. For some cases, the value can be indicated via DCI, while a fixed value is applied in some other cases. For example, with respect to the Msg-3 scheduling, in order to handle the impact of large TA, from implementation perspective, an additional scheduling delay field can be configured by the BS without additional signaling of K_offset before the initial access. Moreover, for some TDD cases, a reference value can be configured first and another value e.g. k can be configured on the top of the reference value (e.g. 12 or 8). For example, with respect to timing offset for DCI scheduled NPUSCH, the reference value is 8, and then another value e.g. 0, 8, 16, 32 is added to obtain the time offset. Then, the corresponding impacts for larger TA in NTN can be absorbed by this reference value.

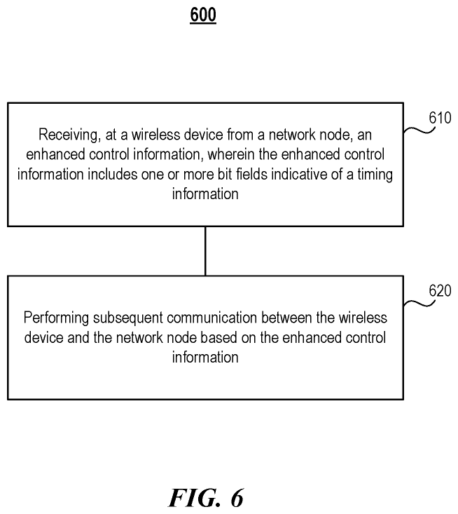

FIG. 6 shows an example of a method 600 for wireless communication. At 610, in some embodiments of the disclosed technology, the method includes receiving, at a wireless device from a network node, an enhanced control information, wherein the enhanced control information includes one or more bit fields indicative of a timing information. At 620, the method includes performing subsequent communication between the wireless device and the network node based on the enhanced control information. At 620, the method includes performing subsequent communication between the wireless device and the network node based on the enhanced control information.

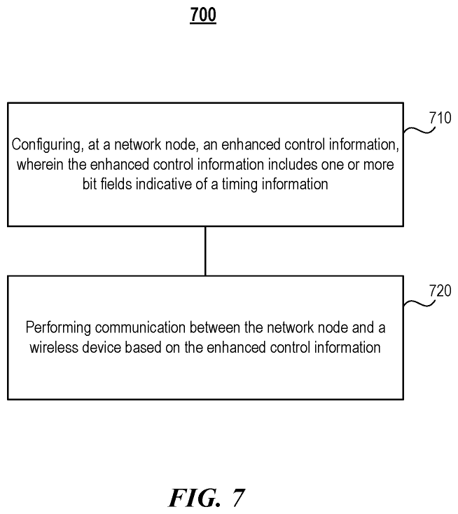

FIG. 7 shows another example of a method 700 for wireless communication. At 710, in some embodiments of the disclosed technology, the method includes configuring, at a network node, an enhanced control information, wherein the enhanced control information includes one or more bit fields indicative of a timing information. At 720, the method includes performing communication between the network node and a wireless device based on the enhanced control information.

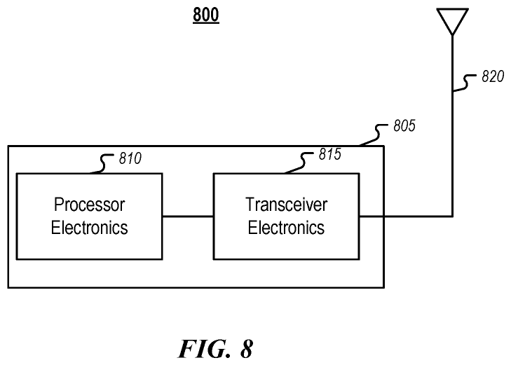

FIG. 8 is a block diagram representation of a portion of a radio station in accordance with one or more embodiments of the present technology can be applied. A radio 805 such as a base station or a wireless device (or UE) can include electronics 810 such as a microprocessor that implements one or more of the wireless techniques presented in this document. The radio 805 can include transceiver electronics 815 to send and/or receive wireless signals over one or more communication interfaces such as antenna 820. The radio 805 can include other communication interfaces for transmitting and receiving data. Radio 805 can include one or more memories (not explicitly shown) configured to store information such as data and/or instructions. In some implementations, the processor electronics 810 can include at least a portion of the transceiver electronics 815. In some embodiments, at least some of the disclosed techniques, modules or functions are implemented using the radio 805. In some embodiments, the radio 805 may be configured to perform the methods described in this document.

Some embodiments may preferably implement one or more of the following solutions, listed in clause-format. The following clauses are supported and further described in the Examples above and throughout this document. As used in the clauses below and in the claims, a wireless terminal may be user equipment, mobile station, or any other wireless terminal including fixed nodes such as base stations. A network node includes a base station including a next generation Node B (gNB), enhanced Node B (eNB), or any other device that performs as a base station. A resource range may refer to a range of time-frequency resources or blocks.

The technical solutions described by the following clauses may be preferably implemented by some embodiments. In the technical solutions described herein in clause format, the network node may be a network device or a network-side equipment such as a base station. A wireless device may be a user equipment, a mobile station, user device, or another wireless device. FIG. 8 shows an example hardware platform for implementing the network node or a wireless device.

Clause 1. A method of wireless communication, comprising: receiving, at a wireless device from a network node, an enhanced control information, wherein the enhanced control information includes one or more bit fields indicative of a timing information; and performing subsequent communication between the wireless device and the network node based on the enhanced control information.

Clause 2. The method of wireless communication of clause 1, wherein the enhanced control information is indicated in a case that a hybrid automatic repeat request (HARQ) process number received from the network node is greater than a threshold value.

Clause 3. The method of wireless communication of clause 2, wherein the hybrid automatic repeat request (HARQ) process number is indicated by the network node.

Clause 4. The method of wireless communication of clause 1, wherein the enhanced control information is indicated in a case that another hybrid automatic repeat request (HARQ) process number is indicated in a same enhanced control information as the HARQ process number that is greater than the threshold value.

Clause 5. The method of wireless communication of clause 1, wherein an indicator indicates a number of time slots after a communication time slot corresponding to a time resource for a HARQ feedback message.

Clause 6. The method of wireless communication of clause 2, wherein the threshold value is pre-configured by a network before receiving the enhanced control information.

Clause 7. The method of wireless communication of clause 1, wherein in case that the one or more bit fields indicative of a timing information are capable or representing a range of values.

Clause 8. The method of wireless communication of clause 1, wherein a value range indicated by the time offset indicator is from 1 to 32 or from 0 to 31.

Clause 9. The method of wireless communication of clause 1, wherein in case that the one or more than one bit fields indicate the timing information, at least one bit field includes at least one of: a modulation and coding scheme (MCS) bit field, or redundancy version (RV) bit field.

Clause 10. The method of wireless communication of clause 1, wherein the network node is a base station of a non-terrestrial network based on a fifth generation (5G) new radio standard or a narrow band Internet of things standard.

Clause 11. The method of wireless communication of clause 1, wherein after receiving the enhanced control information the wireless device does not receive a second control information for a number of time slots.

Clause 12. The method of wireless communication of clause 11, wherein the number of time slots is a sum of a value indicated in a bit field indicative of a timing information and a fixed value.

Clause 13. The method of wireless communication of clause 11, wherein the number of time slots is a value determined between a transmitting time slot and a scheduling slot indicated by the enhanced control information.

Clause 14. The method of wireless communication of clause 1, wherein the enhanced control information includes a bit field indicative of a timing offset in addition to a predetermined reference value.

Clause 15. The method of wireless communication of clause 14, wherein the predetermined reference value is determined via a round trip delay of the network.

Clause 16. The method of wireless communication of clause 1, wherein the enhanced control information includes a bit field indicative of a time domain resource allocation based on a default time domain resource allocation table, and wherein the table is determined based on a slot format indication (SFI) configuration.

Clause 17. A method of wireless communication, comprising: configuring, at a network node, an enhanced control information, wherein the enhanced control information includes one or more bit fields indicative of a timing information; and performing communication between the network node and a wireless device based on the enhanced control information.

Clause 18. The method of wireless communication of clause 17, where the indication is done if the supported hybrid automatic repeat request (HARQ) process number by the network node is greater than a threshold value.

Clause 19. The method of wireless communication of clause 18, where supported hybrid automatic repeat request (HARQ) process number is signaled by network node.

Clause 20. The method of wireless communication of clause 17, where the indication is done if the hybrid automatic repeat request (HARQ) process number indicated in same enhanced control information is greater than a threshold value.

Clause 21. The method of wireless communication of clause 17, wherein the indicator indicates a number of time slots after a communication time slot corresponding to a time resource for a HARQ feedback message.

Clause 22. The method of wireless communication of clause 18, wherein the threshold value is pre-configured by a network before receiving the enhanced control information.

Clause 23. The method of wireless communication of clause 17, wherein the one or more bit fields indicative of a timing information are capable or representing a range of values.

Clause 24. The method of wireless communication of clause 17, wherein a value range indicated by the time offset indicator is from 1 to 32 or from 0 to 31.

Clause 25. The method of wireless communication of clause 17, wherein in case of more than one bit field is used to indicate the a timing information, at least one bit field include at least one of: a modulation and coding scheme (MCS) bit field, or redundancy version (RV) bit field.

Clause 26. The method of wireless communication of clause 17, wherein the network node is a base station of a non-terrestrial network based on a fifth generation (5G) new radio standard or a narrow band Internet of things standard.

Clause 27. The method of wireless communication of clause 17, wherein the enhanced control information includes a bit field indicative of a timing offset in addition to a predetermined reference value.

Clause 28. The method of wireless communication of clause 27, wherein the predetermined reference value is determined via a round trip delay of the network.

Clause 29. The method of wireless communication of clause 17, wherein the enhanced control information includes a bit field indicative of a time domain resource allocation based on a default time domain resource allocation table, and wherein the table is determined based on a slot format indication (SFI) configuration.

Clause 30. An apparatus comprising a processor configured to perform any one or more of clauses 1 to 29.

Clause 31. A computer-readable medium including instructions that when executed by a processor perform a method recited in any one or more of clauses 1 to 29.

It will be appreciated that the present document discloses techniques that can be embodied in various embodiments to establish and manage wireless network including airborne network connectivity. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD -ROM disks. The processor and the memory can be supplemented by, or incorporated in, special purpose logic circuitry.

What is claimed is:

1. A method of wireless communication, comprising:
receiving, at a wireless device from a network node, an enhanced control information, wherein the enhanced control information includes one or more bit fields indicative of a timing information; and
performing subsequent communication between the wireless device and the network node based on the enhanced control information.

2. The method of wireless communication of claim 1, wherein the enhanced control information is indicated in a case that a hybrid automatic repeat request (HARQ) process number received from the network node is greater than a threshold value.

3. The method of wireless communication of claim 2, wherein the hybrid automatic repeat request (HARQ) process number is indicated by the network node.

4. The method of wireless communication of claim 2, wherein the enhanced control information is indicated in a case that another hybrid automatic repeat request (HARQ) process number is indicated in a same enhanced control information as the HARQ process number that is greater than the threshold value, wherein the threshold value is pre-configured by a network before receiving the enhanced control information.

5. The method of wireless communication of claim 1, wherein an indicator indicates a number of time slots after a communication time slot corresponding to a time resource for a HARQ feedback message.

6. The method of wireless communication of claim 1, wherein in case that the one or more bit fields indicative of a timing information are capable or representing a range of values.

7. The method of wireless communication of claim 1, wherein a value range indicated by a time offset indicator is from 1 to 32 or from 0 to 31.

8. The method of wireless communication of claim 1, wherein in case that the one or more than one bit fields indicate the timing information, at least one bit field includes at least one of:
a modulation and coding scheme (MCS) bit field, or
redundancy version (RV) bit field.

9. The method of wireless communication of claim 1, wherein after receiving the enhanced control information the wireless device does not receive a second control information for a number of time slots.

10. The method of wireless communication of claim 9, wherein the number of time slots is a sum of a value indicated in a bit field indicative of a timing information and a fixed value.

11. The method of wireless communication of claim 9, wherein the number of time slots is a value determined between a transmitting time slot and a scheduling slot indicated by the enhanced control information.

12. The method of wireless communication of claim 1, wherein the enhanced control information includes a bit field indicative of a timing offset in addition to a predetermined reference value.

13. A method of wireless communication, comprising:
configuring, at a network node, an enhanced control information, wherein the enhanced control information includes one or more bit fields indicative of a timing information; and
performing communication between the network node and a wireless device based on the enhanced control information.

14. The method of wireless communication of claim 13, where the indication is done if a supported hybrid automatic repeat request (HARQ) process number by the network node is greater than a threshold value.

15. The method of wireless communication of claim 14, where supported hybrid automatic repeat request (HARQ) process number is signaled by network node.

16. The method of wireless communication of claim 14, wherein the threshold value is pre-configured by a network before receiving the enhanced control information.

17. The method of wireless communication of claim 13, wherein the one or more bit fields indicative of a timing information are capable or representing a range of values.

18. The method of wireless communication of claim 13, wherein the enhanced control information includes a bit field indicative of a timing offset in addition to a predetermined reference value.

19. The method of wireless communication of claim 13, wherein the enhanced control information includes a bit field indicative of a time domain resource allocation based on a default time domain resource allocation table, and wherein the table is determined based on a slot format indication (SFI) configuration.

20. An apparatus comprising a processor configured to perform a method comprising:
receive, at a wireless device from a network node, an enhanced control information, wherein the enhanced control information includes one or more bit fields indicative of a timing information; and
perform subsequent communication between the wireless device and the network node based on the enhanced control information.
